(19) United States
(12) Patent Application Publication
(10) Pub. No.: US 2018/0176814 A1
(43) Pub. Date: Jun. 21, 2018

(54) COMMUNICATION CONTROL DEVICE, COMMUNICATION SYSTEM AND COMMUNICATION METHOD

(71) Applicant: FUJITSU LIMITED, Kawasaki-shi (JP)

(72) Inventors: Hiroshi Fujita, Yokosuka (JP); Dai Kimura, Yokohama (JP); Yun Wen, Kawasaki (JP)

(73) Assignee: FUJITSU LIMITED, Kawasaki-shi (JP)

(21) Appl. No.: 15/831,543

(22) Filed: Dec. 5, 2017

(30) Foreign Application Priority Data
Dec. 15, 2016 (JP) 2016-243540

(51) Int. Cl. H04W 28/02; H04L 5/00; H04W 36/22

(52) U.S. Cl. CPC H04W 28/0215; H04W 76/02; H04W 88/12; H04W 36/22; H04L 5/0039; H04L 5/0007

(57) ABSTRACT

A communication control device configured to control a wireless connection between a plurality of terminal devices and a plurality of access points, the communication control device includes a memory, and a processor coupled to the memory and configured to acquire a terminal communication bandwidth which indicates a communication bandwidth to be used by the terminal devices for communication, and a provided communication bandwidth which indicates a communication bandwidth provided by the respective plurality of access points to the respective plurality of terminal devices, select the access point to be wirelessly connected with each of the plurality of terminal devices based on the terminal communication bandwidth and the provided communication bandwidth, and control so that the respective plurality of terminal devices are wirelessly connected with the selected access point.

### CROSS-REFERENCE TO RELATED APPLICATION

This application is based upon and claims the benefit of priority of the prior Japanese Patent Application No. 2016-243540, filed on Dec. 15, 2016, the entire contents of which are incorporated herein by reference.

### FIELD

The embodiments discussed herein relate to a communication control device, a communication system and a communication method.

### BACKGROUND

Recently, access points are often installed in high concentrations accompanying the increase in wireless LAN users in communication systems that use wireless LANs. When access points are installed in high concentrations, radio waves transmitted by the access points collide and interference occurs more easily. Accordingly, a communication system has installed therein a communication control device for controlling the transmission outputs of the access points and the frequency bands and the like of wireless resources allocated to terminal devices.

Further, the communication areas of a plurality of access points overlap each other when access points are installed in high concentrations. Terminal devices located in overlapping communication areas are wirelessly connected to multiple access points among the plurality of access points having overlapping communication areas, and communicate with other communication devices.

An access point wirelessly connected with a terminal device located in overlapping communication areas is, for example, an access point with a favorable radio wave status for radio waves transmitted by the terminal device, or an access point in which the terminal device firstly receives a reply message corresponding to a request message broadcast by the terminal device for wireless connection.

Techniques pertaining to access points are discussed in Japanese Laid-open Patent Publication No. 2014-192897, Japanese National Publication of International Patent Application No. 2013-526128, and Japanese Laid-open Patent Publication No. 2010-056652.

### SUMMARY

According to an aspect of the invention, a communication control device configured to control a wireless connection between a plurality of terminal devices and a plurality of access points, the communication control device includes a memory, and a processor coupled to the memory and configured to acquire a terminal communication bandwidth which indicates a communication bandwidth to be used by the terminal devices for communication, and a provided communication bandwidth which indicates a communication bandwidth provided by the respective plurality of access points to the respective plurality of terminal devices, select the access point to be wirelessly connected with each of the plurality of terminal devices based on the terminal communication bandwidth and the provided communication bandwidth, and control so that the respective plurality of terminal devices are wirelessly connected with the selected access point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a communication system;

FIG. 2 illustrates a configuration example of a communication control device;

FIG. 3 illustrates an example of a configuration example of an access point;

FIG. 4 illustrates an example of a sequence of processing performed by the communication control device for connecting terminal devices to access points;

FIG. 5 illustrates an example of a terminal information table;

FIG. 6 illustrates an example of a processing flow chart of connection AP selection processing;

FIG. 7 illustrates examples of totals of wireless occupancy time rates for each access point among all the connected combinations;

FIG. 8 illustrates an example of the terminal information table when there is no combination in which the total of the wireless occupancy time rates among all the access points is one or less;

FIG. 9 illustrates examples of totals of the wireless occupancy time rates for each access point among all the connected combinations in a case in which there is no combination in which a total of the wireless occupancy time rates is one or less among all the access points;

FIG. 10 illustrates an example of a sequence for connection AP switching control;

FIG. 11 illustrates an example of a processing flow chart of connection AP selection processing according to a modified example;

FIG. 12 illustrates a configuration example of a terminal device;

FIG. 13 illustrates an example of a sequence of requested throughput acquisition processing;

FIG. 14 illustrates a configuration example of the communication control device;

FIG. 15 illustrates an example of a requested throughput table;

FIG. 16 illustrates an example of a configuration of an access point;

FIG. 17 illustrates an example of a sequence for connection AP switching control;

FIG. 18 illustrates a configuration example of a terminal device; and

FIG. 19 illustrates an example of a sequence for connection AP switching control.

### DESCRIPTION OF EMBODIMENTS

When selecting an access point to wirelessly connect to, multiple terminal devices may be concentrated on a specific access point due to the radio wave status of the terminal devices or the reception timing of a reply message. When multiple terminal devices are concentrated on a specific access point, the amount of data to be transmitted and received by the specific access point increases and the wireless resources used by the terminal devices for the wireless communication is insufficient.

Further, even when a few terminal devices are wirelessly connected without multiple terminal devices being concentrated on a specific access point, the amount of wireless resources used by the terminal devices in the wireless communication may be insufficient if the few terminal devices are carrying out a type of communication with a high volume such as for a video streaming service.

Accordingly, one disclosure provides a communication control device, a communication system, and a communication method that use wireless resources in a communication system efficiently.

<Configuration Example of a Communication System>

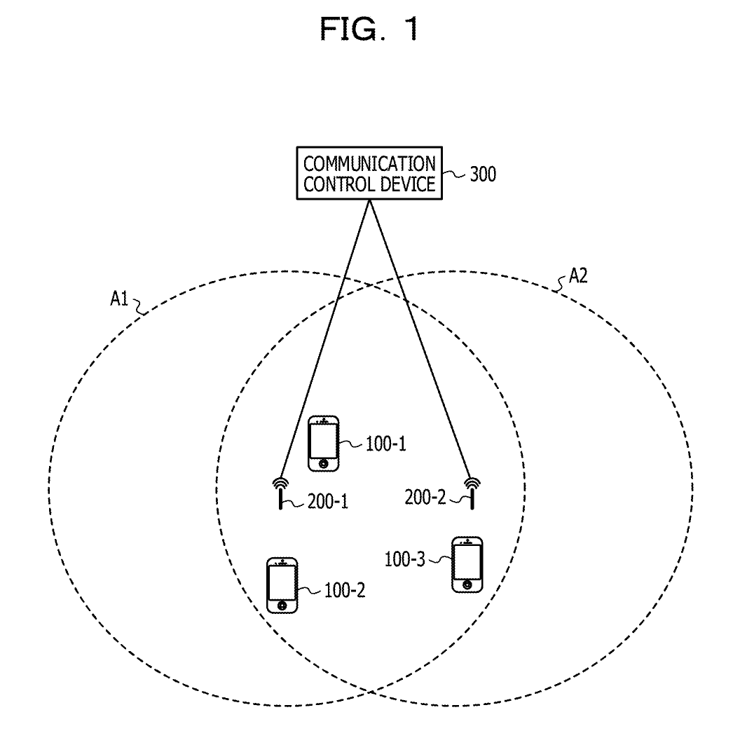

FIG. 1 illustrates a configuration example of a communication system 10. The communication system 10 has terminal devices 100-1 to 100-3 (may be referred to hereinbelow as terminal device 100), access points 200-1 to 200-3, and a communication control device 300. The communication system 10 is a wireless communication system that conforms to a wireless fidelity (Wi-Fi) standard, for example.

The terminal devices 100 wirelessly connect to the access points 200 and transmit and receive packets including data with other communication devices via the access points 200, thereby communicating with the other communication devices. The terminal devices 100 enjoy specific services from other communication devices by communicating with the other communication devices. The specific services include, for example, a video streaming service in which streamed video data is received and replayed, or a voice communication service which allows communication by voice.

The access points 200 are base station devices that wirelessly connect with the terminal devices 100 and relay the communication of the terminal devices 100. The access points 200-1 to 200-2 have respective communication areas A1 and A2. A communication area is a range in which the access points 200-1 and 200-2 are able to wirelessly connect with the terminal devices 100. For example, the terminal device 100 located inside the range of the communication area A1 is able to wirelessly connect with the access point 200-1. In FIG. 1, the terminal devices 100-1 to 100-3 are located in a range in which the areas of the communication areas A1 and A2 overlap each other. Therefore, the terminal devices 100-1 to 100-3 are able to wirelessly connect with either the access point 200-1 or access point 200-2.

The communication control device 300 is a device that controls the wireless connections of the terminal devices 100 and the access points 200 and is, for example, a computer or a server machine. The communication control device 300 is connected by wire with the access points 200 and controls the output of radio waves transmitted by the access points 200 or the frequency bands and the like of the wireless resources allocated by the access points 200 to the terminal devices 100.

Further, the communication control device 300 selects the access points 200 to be wirelessly connected to the terminal devices 100. When a terminal device 100 requests a wireless connection with an access point 200, the communication control device 300 selects the access point 200 to be wirelessly connected to the terminal device 100 in question or a terminal device 100 that is already wirelessly connected based on the terminal information of the terminal device 100 in question or the terminal device 100 that is already wirelessly connected.

The terminal information includes, for example, the communication bandwidth (may be referred to hereinbelow as terminal communication bandwidth) used in the communication by the terminal device 100 for enjoying a service. For example, if the terminal device 100 requests the wireless connection for viewing a video of a video streaming service, the terminal device 100 downloads the video data and the communication bandwidth sufficient for playing the video without a delay is included in the terminal information as the terminal communication bandwidth.

Further, the communication bandwidth that the wirelessly connected access point 200 can allocate (or can provide) to the terminal device 100 is included in the terminal information when, for example, the terminal device 100 is wirelessly connected to the access point 200 (this communication bandwidth may be referred to hereinbelow as provided communication bandwidth). The provided communication bandwidth of the access point 200 with respect to the terminal device 100 is selected by the access point 200 based on the intensity of the degree of interference of the radio waves received by the access point 200 from the terminal device 100. The provided communication bandwidth is a communication bandwidth that can be allocated when the terminal device 100 is wirelessly connected to the access point 200, and is a numerical value present in each terminal device 100 and access point 200.

The communication control device 300 in the communication system 10 carries out the control by acquiring the terminal information, selecting the access points 200 to be wirelessly connected with the respective terminal devices 100-1 to 100-3 based on the acquired terminal information, and wirelessly connecting the terminal devices 100-1 to 100-3 to the selected access points 200.

### First Embodiment

The following is an explanation of the first embodiment. In the first embodiment, the communication control device 300 acquires the terminal communication bandwidths which indicate the communication bandwidths used by the terminal devices 100 for communication, and the provided communication bandwidths which indicate the communication bandwidths provided by the respective plurality of access points 200 to the respective plurality of terminal devices 100. Further, the communication control device 300 selects the access points 200 to be wirelessly connected with each of the plurality of terminal devices 100 based on the terminal communication bandwidth and the provided communication bandwidth. Moreover, the communication control device 300 carries out the control so that each of the plurality of terminal devices 100 are wirelessly connected to the selected access points 200.

<Configuration Example of Communication Control Device>

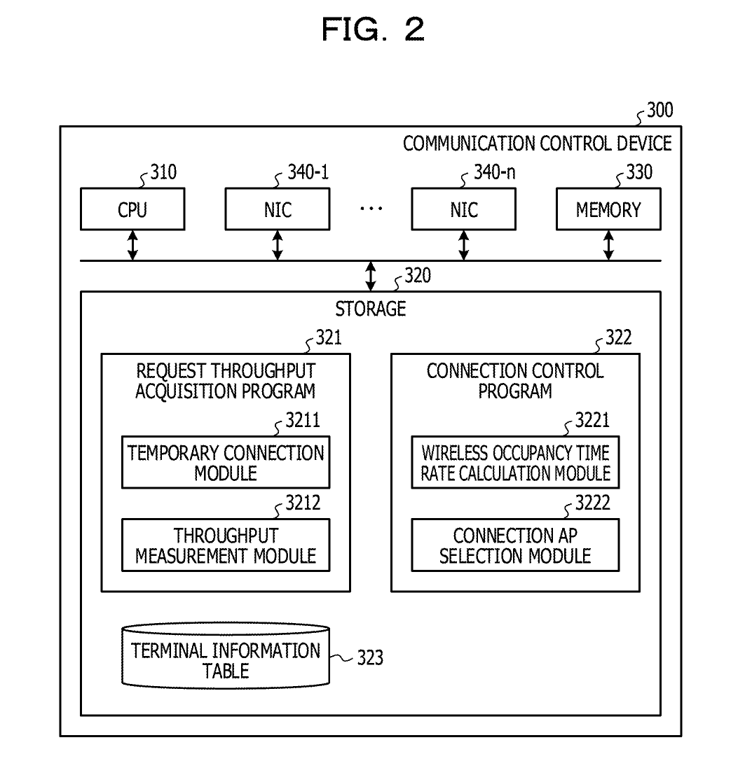

FIG. 2 illustrates a configuration example of the communication control device 300. The communication control device 300 has a central processing unit (CPU) 310, a storage 320, memory 330 such as a dynamic random access memory (DRAM), and network interface cards (NIC) 340-1 to 340-n.

The storage 320 stores programs or data and is an auxiliary storage device such as a flash memory, a hard disk drive (HDD), or a solid state drive (SSD). The storage 320 stores a requested throughput acquisition program 321, a connection control program 322, and a terminal information table 323.

The terminal information table 323 is a table for storing terminal information. The terminal information table 323 stores, for example, identifiers of the terminal devices 100, requested throughputs of the terminal devices 100, and allocatable throughputs allocated by the access points 200 to the terminal devices 100, etc.

The identifier of the terminal device 100 is, for example, an international mobile equipment identifier (IMEI) of the terminal device 100. The identifier of the terminal device 100 is a value or a symbol that uniquely indicates the terminal device 100.

The requested throughput is the communication bandwidth to be used by the terminal device 100 for communication, namely, the terminal communication bandwidth. The requested throughput is decided, for example, in response to the type of application to be executed during the communication. Further, the requested throughput is decided by the service that the communication partner of the terminal device 100 provides. That is, the requested throughput is a throughput that allows the terminal device 100 to enjoy the service without delays during communication.

The allocatable throughput is the communication bandwidth that can be allocated by the access point 200 to the terminal device 100, namely the provided communication bandwidth. The allocatable throughput is decided in response to the signal strength between the terminal device 100 and the access point 200. The allocated throughput is a numerical value that decreases in correspondence to, for example, a greater distance between the terminal device 100 and the access point 200. For example, the allocated throughput is a low numerical value when radio waves are blocked and interference is generated due to buildings and the like between the terminal device 100 and the access point 200. The allocatable throughput is a throughput based on a modulation and coding scheme (MCS) and is determined, for example, based on the intensity and the degree of interference of radio waves received by the access point 200 from the terminal device 100.

The memory 330 is a region for loading the programs stored in the storage 320. The memory 330 is also used by the programs as a region to store data.

The NICs 340-1 to 340-n are network interfaces for connecting with the access points 200. The communication control device 300 communicates with the access points 200 by transmitting and receiving packets to and from the access points 200 via the NICs 340-1 to 340-n.

The CPU 310 establishes an acquisition unit to perform requested throughput acquisition processing by executing the requested throughput acquisition program 321. The requested throughput acquisition processing is processing for acquiring the requested throughput of the terminal device 100.

The CPU 310 performs temporary connection processing by executing a temporary connection module 3211 during the requested throughput acquisition processing. The temporary connection processing is processing to temporarily connect (temporary connection) the terminal device 100 and the access point 200 in order to measure the requested throughput of the terminal device 100.

The CPU 310 performs throughput measurement processing by executing a throughput measurement module 3212 during the requested throughput acquisition processing. The throughput measurement processing is processing for measuring the amount of packet data transmitted and received by the temporarily connected terminal device 100 over a predetermined time period, calculating the throughput of the terminal device 100 from the measurement results, and treating the calculated throughput as the requested throughput of the terminal device 100. That is, the communication control device 300 causes the terminal device 100 to communicate over the predetermined time period and treats the measured throughput of the terminal device 100 as the requested throughput.

The communication control device 300 measures the throughput to be used during communication by the terminal device 100 by temporarily connecting the access point 200 and the terminal device 100 at a large allocatable communication bandwidth, for example, and initiating actual communication with the terminal device 100. Consequently, the communication bandwidth that can be allocated by the temporarily connected access point 200 to the terminal device 100 is desirably as large as possible.

Further, the CPU 310 establishes a control unit and carries out connection control processing by executing the connection control program 322. The connection control processing is processing for controlling the connection between the terminal device 100 and the access point 200.

The CPU 310 establishes a determining unit and carries out wireless occupancy time rate calculation processing by executing a wireless occupancy time rate calculation module 3221. The wireless occupancy time rate calculation processing is processing for deriving a numerical value (may be referred to hereinbelow as wireless occupancy time rate) in which the requested throughput of the terminal device 100 is divided by the allocatable throughput of the access point 200. The wireless occupancy time rate indicates a ratio of the time period during which the terminal device 100 uses the allocated communication bandwidth.

A case in which the wireless occupancy time rate is 1 or less indicates that there is a time period during which the terminal device 100 does not use the allocated communication bandwidth, and a communication bandwidth that is equal to or greater than the communication bandwidth used during communication is allocated to the terminal device 100.

However, a case in which the wireless occupancy time rate is greater than 1 indicates that there is no time period during which the terminal device 100 does not use the allocated communication bandwidth, and the communication bandwidth allocated to the terminal device 100 is insufficient for allowing the terminal device 100 to communicate. That is, the terminal device 100 is unable to acquire a sufficient throughput for enjoying the service.

The CPU 310 establishes a selecting unit and carries out connection AP selection processing by executing a connection AP selection module 3222 during the connection control processing. The connection AP selection processing is processing for selecting the access point 200 that the terminal device 100 will connect to. The communication control device 300 selects the access point 200 to be wirelessly connected to the terminal device 100 based on the wireless occupancy time rate. The communication control device 300, for example, selects a combination of the terminal devices 100 and the access points 200 so that the total of the wireless occupancy time rate of the terminal device 100 to be connected to one access point 200 is equal to or less than 1. The communication control device 300 carries out the connection AP selection processing, for example, when the terminal device 100 requests a connection to the access point 200. Further, the communication control device 300 performs the connection AP selection processing periodically, for example.

The access point 200, for example, may have the processes and tables of the communication control device 300. That is, the communication control device 300 is not necessarily a device separate from the access point 200, and may be an access point selected from the plurality of access points and may control the other access points.

<Configuration Example of Access Point>

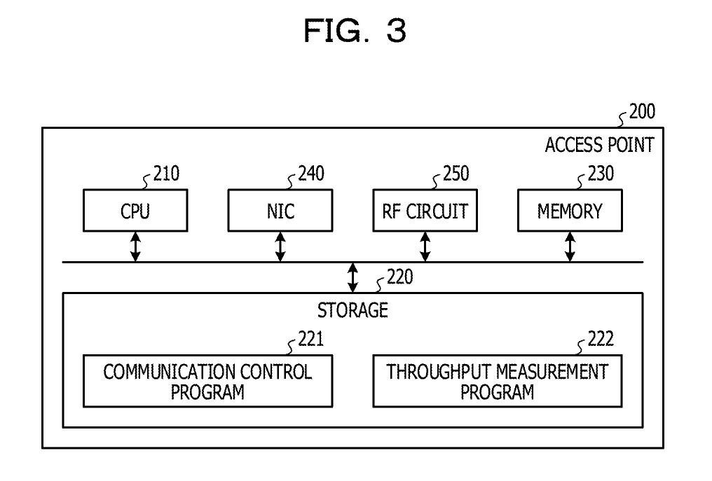

FIG. 3 illustrates a configuration example of the access point 200. The access point 200 has a CPU 210, a storage 220, a memory 230 such as a DRAM, an NIC 240, and a radio frequency (RF) circuit 250.

The storage 220 stores programs or data and is an auxiliary storage device such as a flash memory, a hard disk drive (HDD), or a solid state drive (SSD). The storage 220 stores a communication control program 221 and a throughput measurement program 222.

The memory 230 is a region for loading the programs stored in the storage 220. The memory 230 is also used by the programs as a region to store data.

The NIC 240 is a network interface for connecting with the communication control device 300. The access point 200 communicates with the communication control device 300 by transmitting and receiving packets to and from the communication control device 300 via the NIC 240.

The RF circuit 250 is a device that wirelessly connects with the terminal device 100. The RF circuit 250 has, for example, an antenna and transmits packets including data to the terminal device 100 by transmitting radio waves to the wirelessly connected terminal device 100.

The CPU 210 carries out communication control processing by executing the communication control program 221. The communication control processing is processing for controlling the wirelessly connection with the terminal device 100. The access point 200 wirelessly connects with the terminal device 100 in response to an instruction, for example, from the communication control device 300 during the communication control processing.

The CPU 210 also carries out throughput measurement processing by executing the throughput measurement program 222. The throughput measurement processing is processing for measuring the amount of data included in packets transmitted to and received from the terminal device 100, and transmitting the measurement results to the communication control device 300. Further, the throughput measurement processing may include, for example, processing for calculating the throughput of the terminal device 100 from the measurement results and transmitting the calculated results to the communication control device 300.

<Access Point Control Processing>

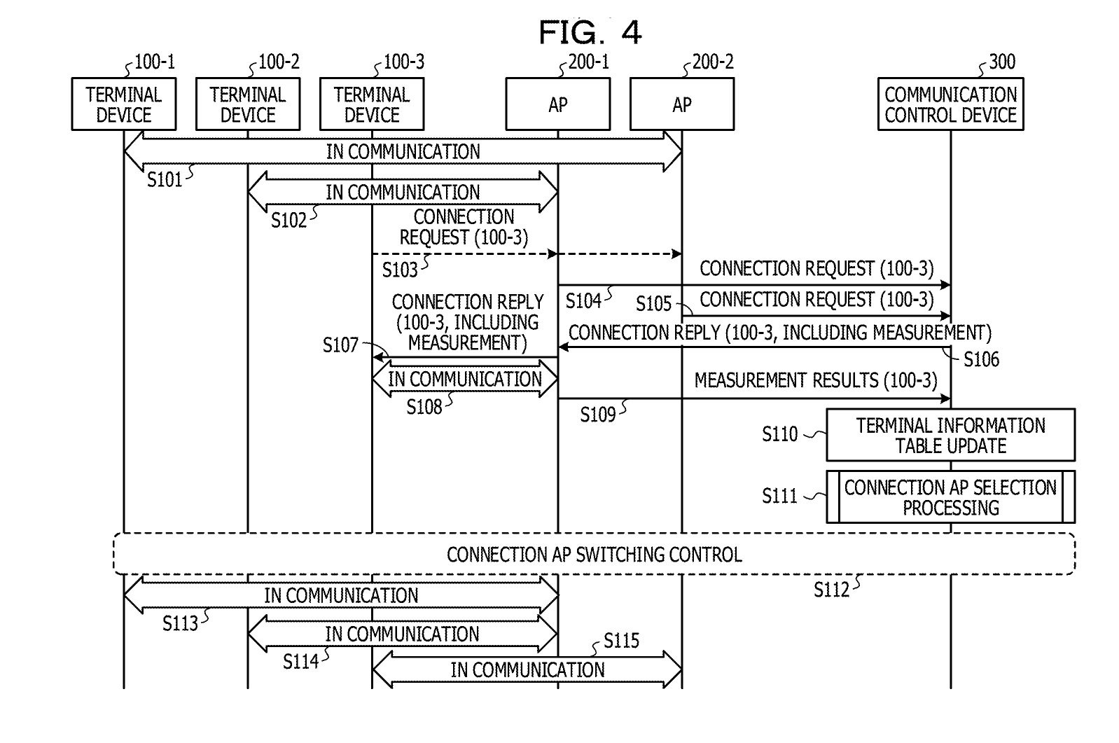

FIG. 4 illustrates an example of a sequence of processing performed by the communication control device 300 for connecting the terminal devices 100-1 to 100-3 to the access points 200-1 and 200-2. The terminal device 100-1 and the access point 200-2 and the terminal device 100-2 and the access point 200-1 are wirelessly connected and in communication (S101, S102).

The terminal device 100-3 transmits a connection request for requesting a wireless connection with the access point 200-1 or 200-2, to the access points 200-1 and 200-2 by broadcasting (S103). Hereinbelow, the dotted line arrows indicate the connection request transmitted by broadcasting.

The access points 200-1 and 200-2 receive the connection request and transmit the received connection request to the communication control device 300 (S104, S105). The communication control device 300 receives the connection requests and transmits a connection reply for enabling the terminal device 100-3 to be connected to the access point 200-1 or 200-2 in order to measure the throughput of the terminal device 100-3 (S106).

In FIG. 4, the connection reply in S106 is transmitted to the access point 200-1, but may be transmitted to the access point 200-2. The connection of the terminal device 100-3 in the connection reply in S106 is a connection for measuring the throughput of the terminal device 100-3, and the access point 200 connected to the terminal device 100-3 may be able to measure the throughput of the terminal device 100-3 over the predetermined time period.

Further, the connection reply in S106 includes information elements for requesting the measurement of the throughput of the terminal device 100-3. The access point 200 that receives the connection reply including the information elements for requesting the measurement of the throughput measures, over the predetermined time period, the throughput of the terminal device 100 that is the object of the measurement request, and transmits the measured results to the communication control device 300.

The access point 200-1 receives the connection reply and transmits the connection reply to the terminal device 100-3 (S107). The terminal device 100-3 receives the connection reply from the access point 200-1 and wirelessly connects to and enters into communication with the access point 200-1 (S108).

The access point 200-1 measures the amount of data of the packets transmitted to and received from the terminal device 100-3 and calculates the throughput of the terminal device 100-3. Then, the access point 200-1 treats the calculated throughput as the requested throughput of the terminal device 100-3 and transmits the measurement results to the communication control device 300 (S109).

The communication control device 300 receives the requested throughput of the terminal device 100-3 and updates the terminal information table 323 (S110).

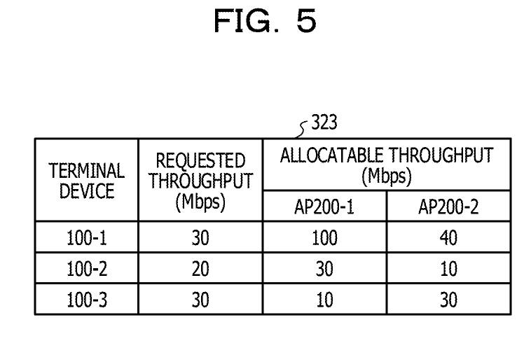

FIG. 5 illustrates an example of the terminal information table 323. The requested throughputs of the terminal devices 100-1 to 100-3 and the allocatable throughputs for each of the access points 200 are stored in the terminal information table 323. According to FIG. 5, the terminal device 100-1 has, for example, a requested throughput of 30 megabits per second (Mbps), an allocatable throughput with the access point 200-1 of 100 Mbps, and an allocatable throughput with the access point 200-2 of 40 Mbps.

The access points 200 measure the reception power and the degree of interference of the connection requests from the terminal devices 100 and determine the allocatable throughputs to the terminal devices 100. The access points 200 then include the allocatable throughputs in the connection requests, for example, and transmit the connection requests to the communication control device 300. The communication control device 300 updates the terminal information table 323 each time an allocatable throughput is received.

Returning to the sequence in FIG. 4, after the update of the terminal information table 323, the communication control device 300 performs the connection AP selection processing (S111).

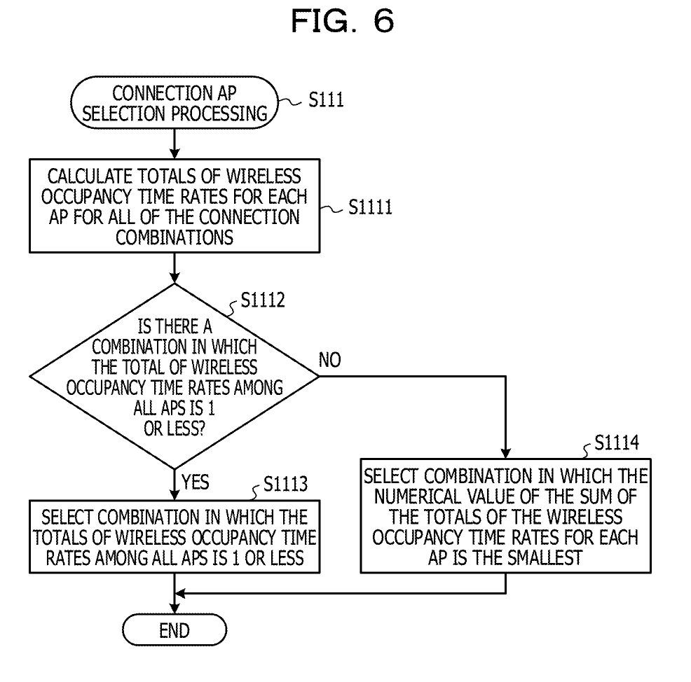

FIG. 6 illustrates an example of a processing flow chart of the connection AP selection processing. The communication control device 300 calculates the total of the wireless occupancy time rates of the terminal devices 100 connected to each access point 200 among all of the combinations of connections (S1111).

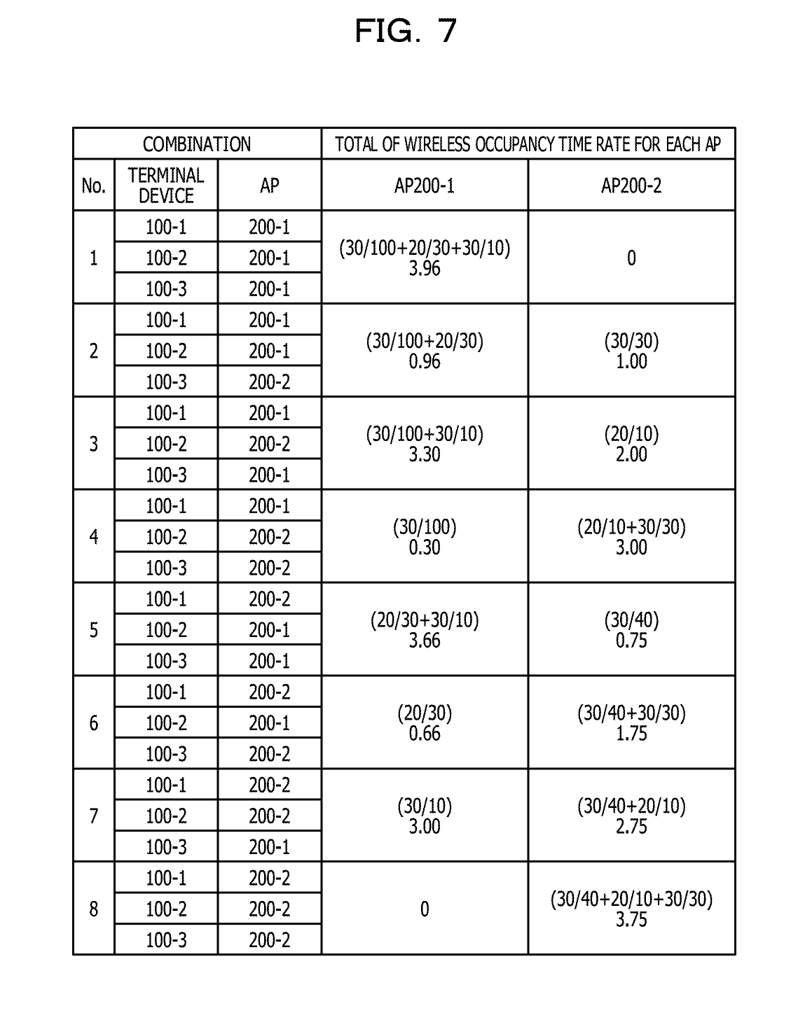

FIG. 7 illustrates the totals of wireless occupancy time rates of the terminal devices 100 connected to each access point 200 among all of the combinations of connections. The requested throughputs and the allocatable throughputs of the terminal devices 100-1 to 100-3 use the numerical values indicated in FIG. 5.

For example, combination no. 2 is explained. Combination no. 2 is a combination of the connections of the terminal devices 100-1 and 100-2 to the access point 200-1 and the connection of the terminal device 100-3 to the access point 200-2.

The wireless occupancy time rate of the terminal device 100-1 is a numerical value (30/100) derived by dividing the requested throughput of 30 Mbps of the terminal device 100-1 by the allocatable throughput of 100 Mbps of the access point 200-1. Similarly, the wireless occupancy time rate of the terminal device 100-2 is 20/30. Consequently, the total of the wireless occupancy time rates of the terminal devices 100 connected to the access point 200-1 is 0.96 (rounded off to three decimal places or less).

The wireless occupancy time rate of the terminal device 100-3 is a numerical value (30/30) derived by dividing the requested throughput of 30 Mbps of the terminal device 100-3 by the allocatable throughput of 30 Mbps of the access point 200-2. Consequently, the total of the wireless occupancy time rates of the terminal devices 100 connected to the access point 200-2 is 1.00.

The communication control device 300 similarly calculates the totals of the wireless occupancy time rates for each access point 200 for all of the combinations.

Returning to the processing flow chart in FIG. 6, the communication control device 300 determines which of the combinations has a total of the wireless occupancy time rates for all of the access points that is 1 or less (S1112). According to FIG. 7, because of the presence of the combination no. 2 in which the totals of the wireless occupancy time rates is 0.9 with the access point 200-1 and 1.00 with the access point 200-2, the communication control device 300 determines that there is a combination in which the total of the wireless occupancy time rates for all the access points is 1 or less (S1112: Yes).

The communication control device 300 then selects the combination no. 2 in which the total of the wireless occupancy time rates for all the access points 200 is 1 or less, as the combination for the connections between the terminal devices 100 and the access points 200 (S1113).

However, there may be case in which there is no combination in which the total of the wireless occupancy time rates for all the access points 200 is 1 or less based on the numerical values of the requested throughputs or the allocatable throughputs of the terminal devices 100.

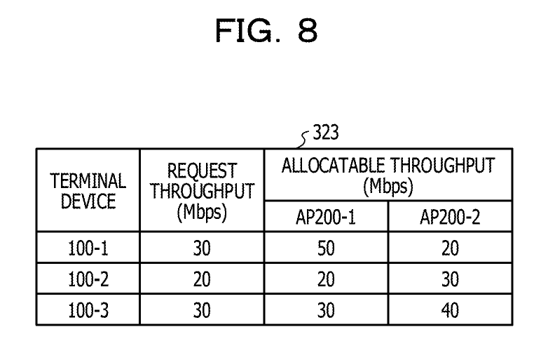

FIG. 8 illustrates an example of the terminal information table 323 when there is no combination in which the total of the wireless occupancy time rates among all the access points 200 is one or less. The communication control device 300 calculates the totals of the wireless occupancy time rates for all the access points among all of the combinations based on the numerical values in FIG. 8 (S1111).

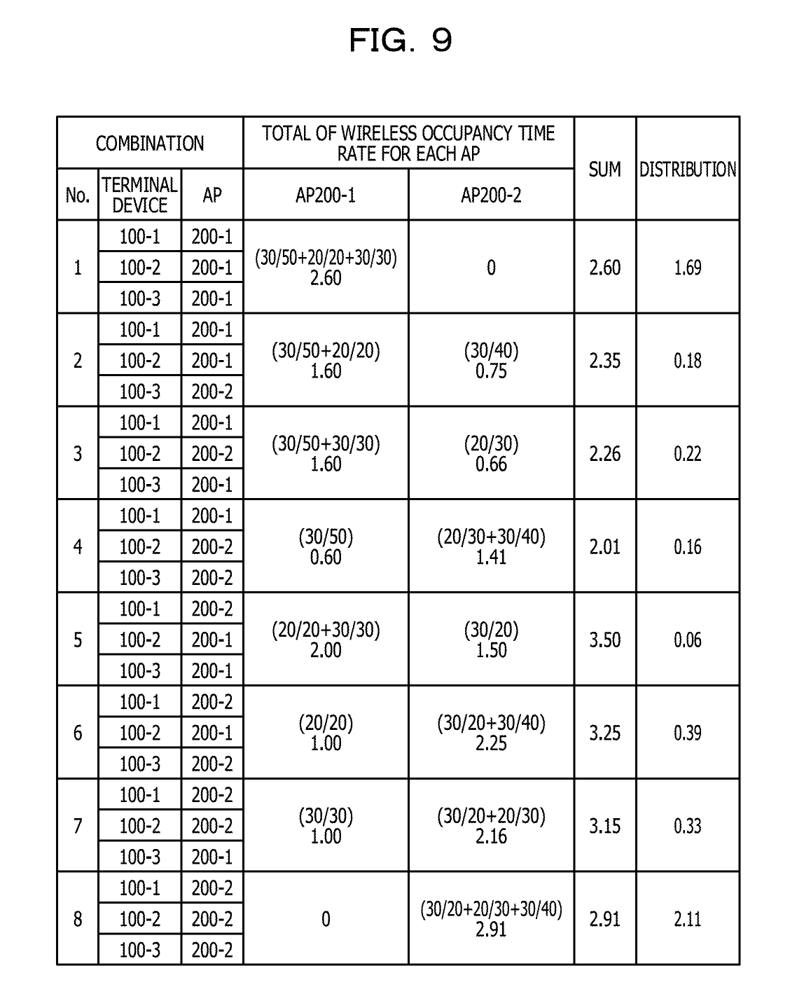

FIG. 9 illustrates an example of the totals of the wireless occupancy time rates for each access point among all the connected combinations in a case in which there is no combination in which a total of the wireless occupancy time rates is one or less among all the access points. According to FIG. 9, there is no combination in which the total of the wireless occupancy time rates for all of the access points is 1 or less (S1112: No). Consequently, the communication control device 300 chooses the combination for which the numerical value that is the sum of the wireless occupancy time rates for each of the access points 200 is the smallest (S1114). The communication control device 300 selects the combination no. 4 which has the smallest sum of 2.01, according to FIG. 9, as the combination of the terminal devices 100 and the access points 200.

Returning to the sequence in FIG. 4, the communication control device 300 executes the connection AP selection processing of S111 and thereafter carries out a connection AP switching control (S112). The connection AP switching control of S112 is processing for controlling the connections the terminal devices 100 so as to achieve the selected combination between the terminal devices 100 and the access points 200.

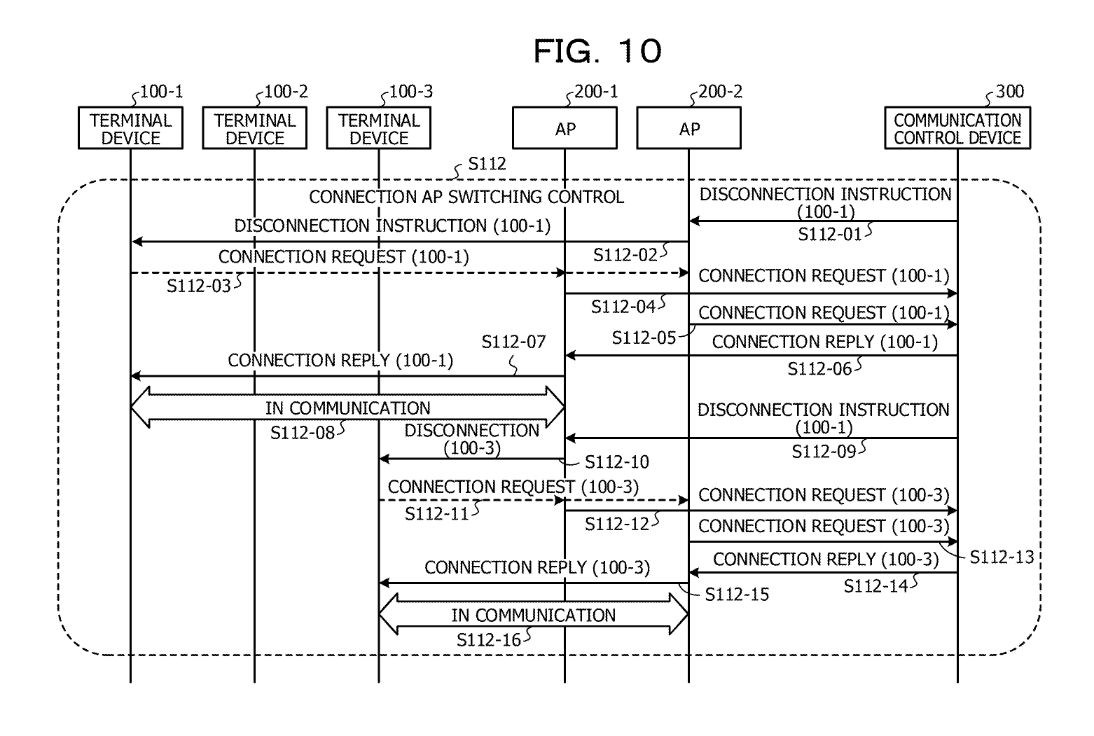

FIG. 10 illustrates an example of a sequence for the connection AP switching control. A case in which the combination no. 2 in FIG. 7 is selected as the combination of the terminal devices 100 and the access points 200 is discussed in FIG. 10.

The communication control device 300 transmits a disconnection instruction for disconnecting the wireless connection between the access point 200-2 and the terminal device 100-1 (S112-01). The terminal device 100-1 is connected to the access point 200-1 in the combination no. 2, therefore the connection with the access point 200-2 is disconnected.

The access point 200-2 receives the disconnection instruction and transmits the disconnection instruction to the terminal device 100-1 (S112-02) and disconnects the connection with the terminal device 100-1. The terminal device 100-1 transmits a connection request to the access points 200-1 and 200-2 by broadcasting in order to continue communication because the connection with the access point 200-2 has been disconnected (S112-03). The access points 200-1 and 200-2 receive the connection request and transmit the received connection request to the communication control device 300 (S112-04, S112-05). The communication control device 300 transmits a connection reply for initiating the connection of the terminal device 100-1 to the access point 200-1 so as to achieve the combination no. 2 (S112-06). The access point 200-1 receives the connection reply, establishes a wireless connection and enters into communication with the terminal device 100-1 (S112-08).

The communication control device 300 transmits a disconnection instruction for disconnecting the wireless connection between the access point 200-1 and the terminal device 100-3 (S112-09). The terminal device 100-3 is connected to the access point 200-3 in the combination no. 2, therefore the connection with the access point 200-1 is disconnected.

The access point 200-1 receives the disconnection instruction and transmits the disconnection instruction to the terminal device 100-3 (S112-10) and disconnects the connection with the terminal device 100-3. The terminal device 100-3 transmits a connection request to the access points 200-1 and 200-2 by broadcasting in order to continue communication because the connection with the access point 200-1 has been disconnected (S112-11). The access points 200-1 and 200-2 receive the connection request and transmit the received connection request to the communication control device 300 (S112-12, S112-13). The communication control device 300 transmits a connection reply for initiating the connection of the terminal device 100-3 to the access point 200-2 so as to achieve the combination no. 2 (S112-14). The access point 200-2 receives the connection reply, establishes a wireless connection and enters into communication with the terminal device 100-2 (S112-16).

The terminal device 100-2 is connected to the access point 200-1 in the combination no. 2. The terminal device 100-2 is in communication with the access point 200-1 and may maintain the connection with access point 200-1 as-is. Consequently, the communication control device 300 does not carry out the processing pertaining to the disconnection instruction or the connection reply and the like with the terminal device 100-2.

Returning to the sequence in FIG. 4, the combination no. 2 is achieved in which the terminal devices 100-1 and 100-2 are in communication with the access point 200-1 (S113, S114) and the terminal device 100-3 is in communication with the access point 200-2 (S115).

In the first embodiment, the communication control device 300 calculates the totals of the wireless occupancy time rates for each access point 200 and selects the combination of the terminal devices 100 and the access points 200 based on the calculated totals. The communication control device 300 preferentially selects the combination in which the totals of the wireless occupancy time rate of all of the access points 200 is equal to or less than 1 when selecting the combination of the terminal devices 100 and the access points 200. As a result, a combination of the terminal devices 100 and the access points 200 in which the requested throughputs of the terminal devices 100 are met can be selected and the wireless resources in the communication system 100 can be used effectively.

The communication control device 300 also determines a combination in which the sum of the totals of the wireless occupancy time rates of all of the access points 200 is the smallest value, as the combination of the terminal devices 100 and the access points 200 when there is no combination in which the total of the wireless occupancy time rates is 1 or less. A combination having the smallest sum is a combination, for example, in which the time period for the terminal device 100 to communicate at less than the requested throughput is small, that is, a combination in which the time period during which the service to be enjoyed by the terminal device 100 is delayed is small.

### First Modified Example of First Embodiment

In the first modified example of the first embodiment, the communication control device 300 selects a combination in which the distribution of the totals of the wireless occupancy time rates of each access point 200 is the smallest value, as the combination of the terminal devices 100 and the access points 200 when there is no combination in which the total of the wireless occupancy time rates is 1 or less among all of the access points 200.

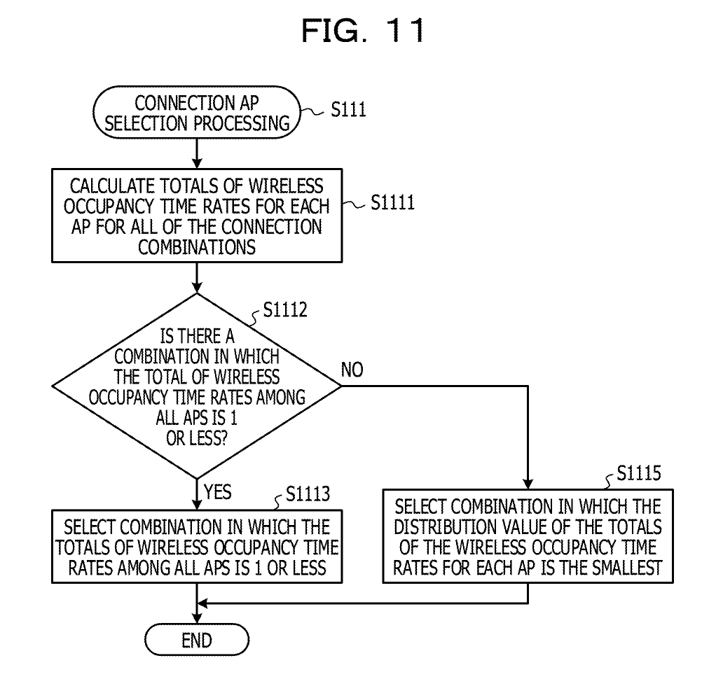

FIG. 11 illustrates an example of a processing flow chart of connection AP selection processing according to the first modified example. The processing from S111 to S1113 is the same as in the processing flow chart in FIG. 6.

When there is no combination in which the totals of the wireless occupancy time rates among all of the access points 200 is 1 or less (S1112: No), the communication control device 300 selects a combination in which the distribution of the totals of the wireless occupancy time rates of the access points 200 is the smallest as the combination of the terminal devices 100 and the access points 200 (S1115).

The distribution is, for example, a numerical value that indicates the degree of variation among subjects. The distribution is calculated using the following formula (1), for example.

V_{X}={(S₁−S_{AVE})²+(S₂−S_{AVE})²+ . . . +(S_{N}−S_{AvE})²)}/N formula (1)

V_{X} is the distribution of combination no. X. S_{Y} is the total of the wireless occupancy time rates of the access point 200-Y. S_{AVE} is the average value of S_{Y} for the applicable combination. N is the number of access points 200 in the applicable combination.

FIG. 9 illustrates the distribution of each combination calculated based on formula (1). The communication control device 300 selects the combination no. 5 which has the smallest distribution as the combination of the terminal devices 100 and the access points 200 (S1115).

The combination with the smallest distribution of the totals of the wireless occupancy time rates for each access point 200 is the combination in which the difference between the totals of the wireless occupancy time rates for each access point 200 is small. The time periods in which communication is not possible at the requested throughput of the terminal device 100 are numerical values close to each other among any of the access points 200 in the applicable combination. Therefore, the probability that unfairness, such as when the requested throughput of one terminal device 100 is achieved but the requested throughput of another terminal device 100 is almost never achieved, will occur among the terminal devices 100 is low. That is, when the difference in the degree of achieving the requested throughput of the terminal device 100 is small, fairness among the terminal devices 100 can be achieved.

### Second Modified Example of First Embodiment

In the second modified example of the first embodiment, the communication control device 300 selects a combination the terminal devices 100 and the access points 200 in accordance with a priority level of the communication of the terminal devices 100 when there is no combination in which the totals of the wireless occupancy time rates is 1 or less among all of the access points 200.

The priority level for communication of the terminal device 100 is, for example, an access category (AC) of the packets to be used during communication. The access categories are classified, for example, into AC_VO (voice), AC_VI (video), AC_BE (best effort), and AC_BK (background). The AC_VO and the AC_VI have a relatively high priority level for communication for the terminal devices 100 because these access categories are used in communication for guaranteeing a throughput (e.g., requested throughput) of a predetermined level or higher. Conversely, the AC_BE and the AC_BK have a relatively low priority level of communication for the terminal devices 100 because these access categories are used in communication for which the guarantee of throughput is not expected. The communication control device 300 acquires the access categories of the packets used during the communication of the terminal device 100 and determines the priority level for the communication of the terminal device 100.

Further, the priority levels of communication of the terminal devices 100 are set, for example, for each terminal device 100. The priority level for each terminal device 100 is registered, for example, in the communication control device 300 by an administrator of the communication system 10. The communication control device 300 refers to the registered priority levels and determines the priority level for the communication of the terminal device 100.

The communication control device 300 selects a combination of the terminal devices 100 and the access points 200 based on the priority levels of the communication of the terminal devices 100 when there is no combination in which the totals of the wireless occupancy time rates is 1 or less among all of the access points 200 (e.g., FIG. 8, 9).

For example, if the packets of the communication of the terminal device 100-3 have high priority levels, such as AC_VO or AC_VI, the connection request of the terminal device 100-3 is refused because the requested throughput is not able to be guaranteed. However, if the packets of the communication of the terminal device 100-3 have low priority levels, such as AC_BE or AC_BK, the combination of the terminal devices 100 and the access points 200 is selected based on, for example, the first embodiment or the first modified example of the first embodiment because the requested throughput does not have to be guaranteed.

Further, if, for example, the packets of the communication of the terminal device 100-3 have high priority levels, such as AC_VO or AC-VI, the combination of the terminal devices 100 and the access points 200 may be selected while prioritizing achievement of the requested throughput of the terminal device 100-3. The communication control device 300 selects, for example, the combination no. 2 in which the total of the wireless occupancy time rate of the AP 200-2 connected with the terminal device 100-3 is 0.75 in FIG. 9. Further, the communication control device 300 may select the combination no. 7 in which the total of the wireless occupancy time rate of the AP 200-1 connected with the terminal device 100-3 is 1.00 in FIG. 9.

In the second modified example, the combination of the terminal devices 100 and the access points 200 is selected in consideration of the priority levels for communication of the terminal devices 100. As a result, the communication control device 300 refuses communication in which the throughput is not able to be guaranteed and is able to select a combination of the terminal devices 100 and the access points 200 that prioritizes the throughput for communication having a high priority level.

### Second Embodiment

The following is an explanation of a second embodiment. In the second embodiment, the communication control device 300 acquires the requested throughput from the terminal device 100.

<Configuration Example of Terminal Device>

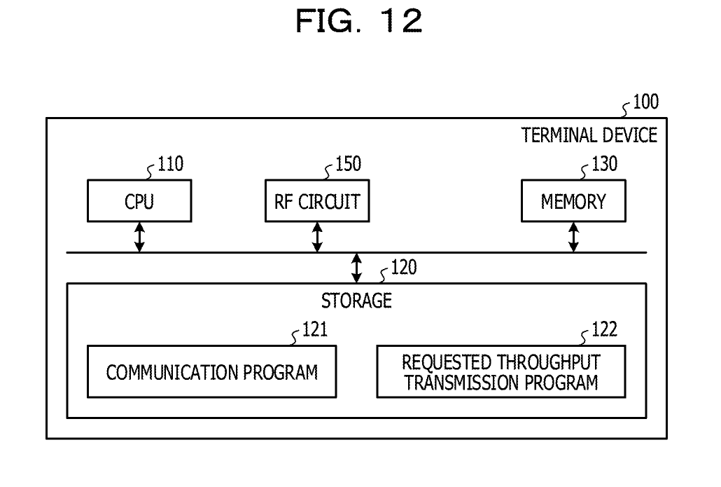

FIG. 12 illustrates a configuration example of the terminal device 100. The terminal device 100 has a CPU 110, a memory 130 such as a DRAM, and an RF circuit 150. The storage 120 stores programs or data and is an auxiliary storage device such as a flash memory, an HDD, or an SSD. The storage 120 stores a communication program 121 and a requested throughput transmission program 122.

The CPU 110 performs transmission processing by executing the communication program 121. The communication processing is processing for communicating with a communication partner device. The terminal device 100 transmits a connection request to the access point 200 and wirelessly connects with the access point 200 in the communication processing. Further, the terminal device 100 communicates by transmitting and receiving packets to and from the communication partner device via the connected access point 200 in the communication processing.

The CPU 110 also carries out throughput transmission processing by executing the requested throughput transmission program 122. The requested throughput transmission processing is processing for transmitting the requested throughput of the terminal device 100 to the communication control device 300 via the connected access point 200.

<Requested Throughput Acquisition Processing>

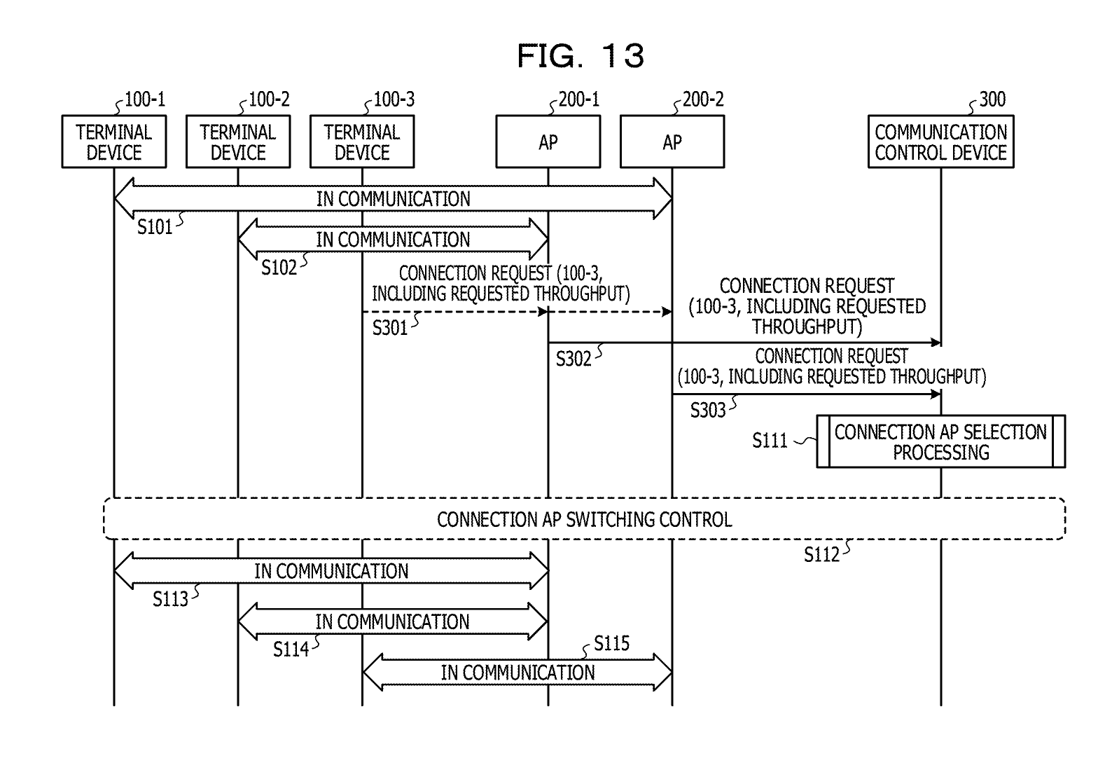

FIG. 13 illustrates an example of a sequence of the requested throughput acquisition processing. The terminal device 100-1 and the access point 200-2 and the terminal device 100-2 and the access point 200-1 are wirelessly connected and in communication (S101, S102) in the same way as in the sequence depicted in FIG. 4.

The terminal device 100-3 transmits the connection request including the requested throughput to the access point 200-1 and 200-2 (S301).

The terminal device 100-3 sets a throughput for which, for example, video data can be received without delays as the requested throughput when executing a video viewing service. Further, the terminal device 100-3 may calculate the requested throughput in accordance with, for example, a service provided by the communication device that is the connection target.

The access points 200-1 and 200-2 transmit the received connection request to the communication control device 300 (S302, S303). The communication control device 300 receives the requested throughput of the terminal device 100-3 included in the connection request and updates the terminal information table 323. The processing from S111 to S115 hereinbelow is the same as the sequence in FIG. 4.

In the second embodiment, the terminal device 100 determines the requested throughput and transmits the requested throughput to the communication control device 300. As a result, the requested throughput of the terminal device 100 can be acquired without connecting the terminal device 100 to an access point and taking actual measurements.

### Modified Example of Second Embodiment

While the terminal device 100 transmits the requested throughput in the second embodiment, the terminal device 100 may transmit a uniform resource locator (URL) of the connection target or the application name of the service to be enjoyed instead of the requested throughput. The communication control device 300 determines the requested throughput based on the received URL or application name. In the modified example, a case in which an application name to be used by the terminal device 100 is transmitted will be discussed as an example.

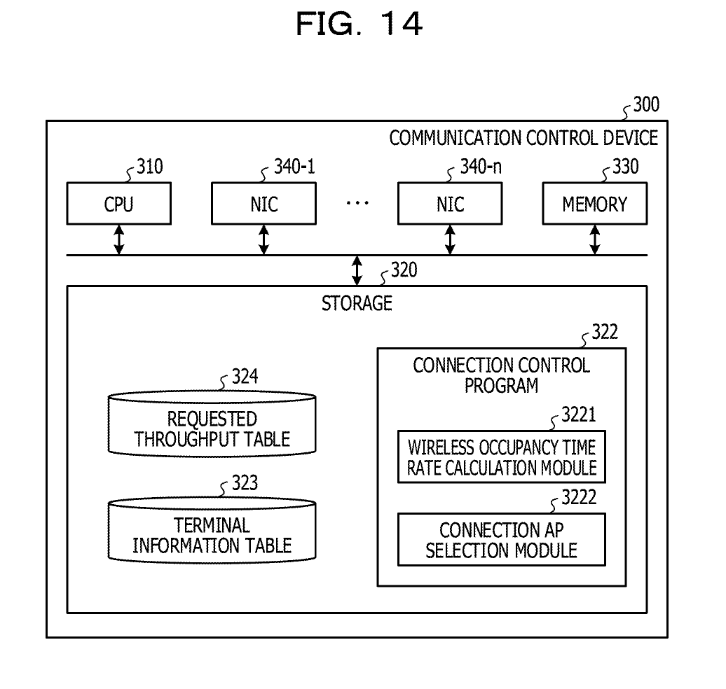

FIG. 14 illustrates a configuration example of the communication control device 300. The communication control device 300 stores a requested throughput table 324 in the storage 320.

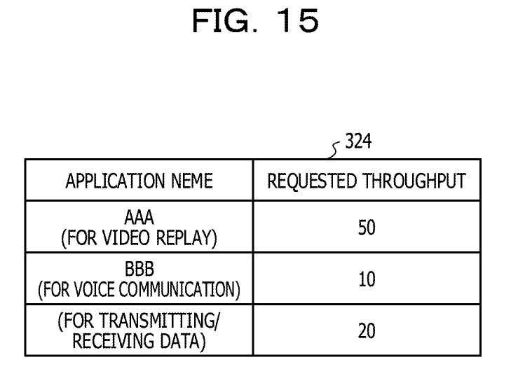

FIG. 15 illustrates an example of the requested throughput table 324. The requested throughput table 324 stores application names and corresponding requested throughputs. The communication control device 300 receives the application name and extracts the requested throughput corresponding to the received application name from the requested throughput table 324. The communication control device 300 then updates the terminal information table 323 using the extracted requested throughput as the requested throughput of the terminal device 100.

The communication control device 300 receives the connection request including, for example, the application name “AAA” from the terminal device 100-3. The communication control device 300 updates the terminal information table 323 using 50 Mbps corresponding to the application name “AAA” as the requested throughput of the terminal device 100-3 according to FIG. 15.

In the modified example, an application or a URL is received from the terminal device 100 instead of the requested throughput value. The communication control device 300 then extracts the corresponding requested throughput based on the requested throughput table. The terminal device 100 transmits, to the communication control device 300, the application name or the URL and the like to be used and for which the requested throughput can be acquired without calculating the requested throughput and without complex logic such as mathematical processing. As a result, the amount of programs to be added to the terminal device 100 can be suppressed.

### Third Embodiment

The following is an explanation of a third embodiment. In the third embodiment, the communication control device 300 transmits an AP switching instruction to the access point 200 during the connection AP switching control.

<Configuration Example of Access Point>

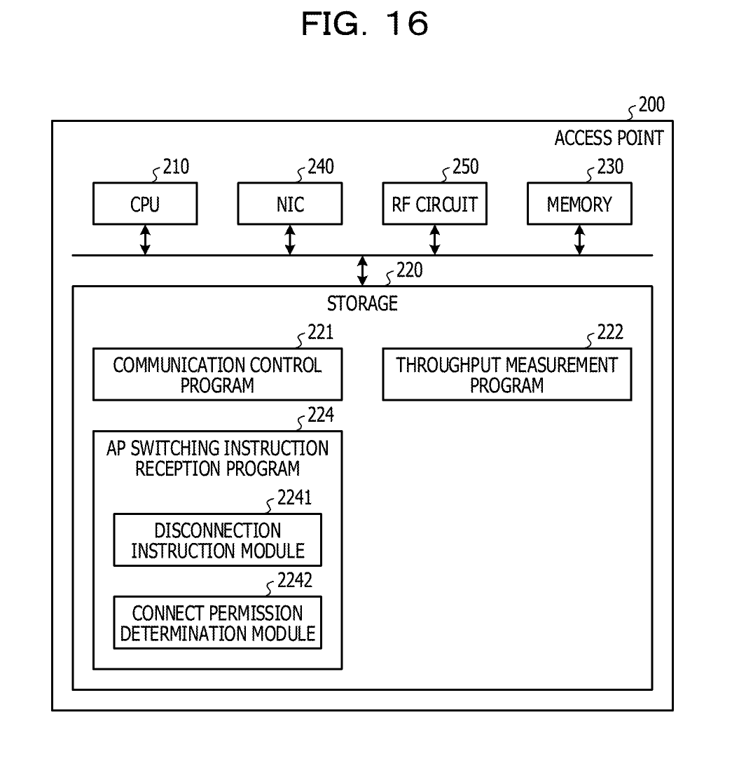

FIG. 16 illustrates an example of a configuration of the access point 200. The access point 200 stores an AP switching instruction reception program 224 in the storage 220.

The CPU 210 performs AP switching instruction reception processing by executing the AP switching instruction reception program 224. The AP switching instruction reception processing is processing performed when an AP switching instruction is received from the communication control device 300. The AP switching instruction is a message that includes an identifier of the terminal device 100 that will be switched to the connection target, and identifiers of the access points 200 that are the switching origin and the switching target.

The CPU 210 executes a disconnection instruction module 2241 and performs disconnection instruction processing in the AP switching instruction reception processing. The disconnection instruction processing is processing in which the access point 200 that is the switching origin transmits the disconnection instruction to the terminal device 100 that is to be switched and disconnects the connection with the terminal device 100.

The CPU 210 executes a connection permission determination module 2242 and performs connection permission determination processing during the AP switching instruction reception processing. The connection permission determination processing is processing which involves the access point 200 that is the connection target receiving a connection request from the terminal device 100 that is to be switched and permitting the connection with the applicable terminal device 100, and transmitting a connection reply to the applicable terminal device 100.

<Connection AP Switching Control Processing>

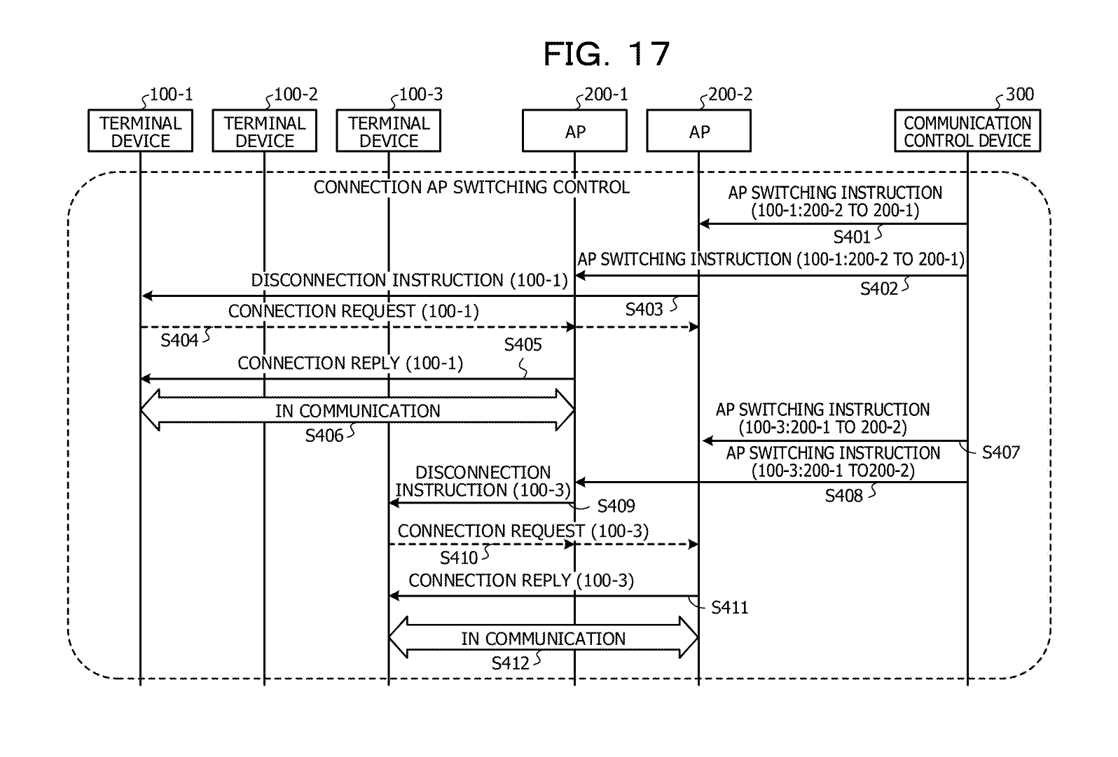

FIG. 17 illustrates an example of a sequence for the connection AP switching control. A case in which the combination no. 2 in FIG. 7 is selected as the combination of the terminal devices 100 and the access points 200 is discussed in FIG. 17.

The communication control device 300 transmits AP switching instructions to the access points 200-1 and 200-2 (S401, S402). The AP switching instructions in S401 and S402 include switching the connection target of the terminal device 100-1 from the access point 200-2 to the access point 200-1.

The access point 200-2 receives the AP switching instruction and transmits a disconnection instruction to the terminal device 100-1 in order to disconnect the connection with the terminal device 100-1 (S403).

The terminal device 100-1 for which the connection with the access point 200-2 is to be disconnected transmits a connection request to the access points 200-1 and 200-2 (S404). The access point 200-1 recognizes the fact that the access point 200-1 itself has become the switching target of the terminal device 100-1 upon receiving the AP switching instruction. Therefore, the access point 200-1 transmits a connection reply to the terminal device 100-1 (S405) and enters into communication with the terminal device 100-1 (S406).

Similarly, the communication control device 300 switches the connection target of the terminal device 100-3 from the access point 200-1 to the access point 200-2 (S407 to S412).

In the third embodiment, the communication control device 300 transmits the AP switching instruction to the access point 200. The access point 200 that receives the AP switching instruction transmits the connection request to the communication control device 300, and the access point 200 that is the connection target of the terminal device 100 is switched without receiving a connection reply from the communication control device 300. As a result, the packet transmission frequency between the access points 200 and the communication control device 300 is reduced and the amount of communication in the communication system 10 can be suppressed.

### Modified Example of Third Embodiment

While the communication control device 300 transmits the AP switching instruction to the access point 200 in the third embodiment, the communication control device 300 transmits the AP switching instruction to the terminal device 100 in a modified example.

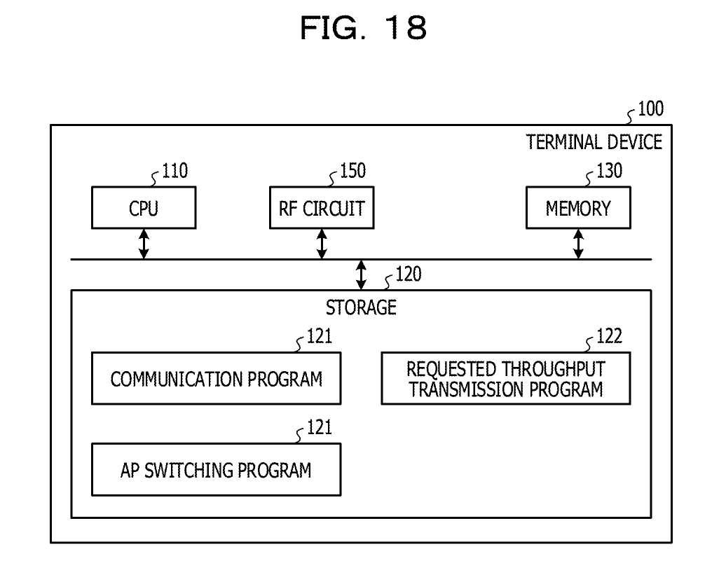

FIG. 18 illustrates a configuration example of the terminal device 100. The terminal device 100 stores an AP switching program 123 in the storage 120.

The CPU 110 performs AP switching processing by executing the AP switching program 123. The AP switching processing is processing for switching the access point to be connected to in accordance with an AP switching instruction from the communication control device 300.

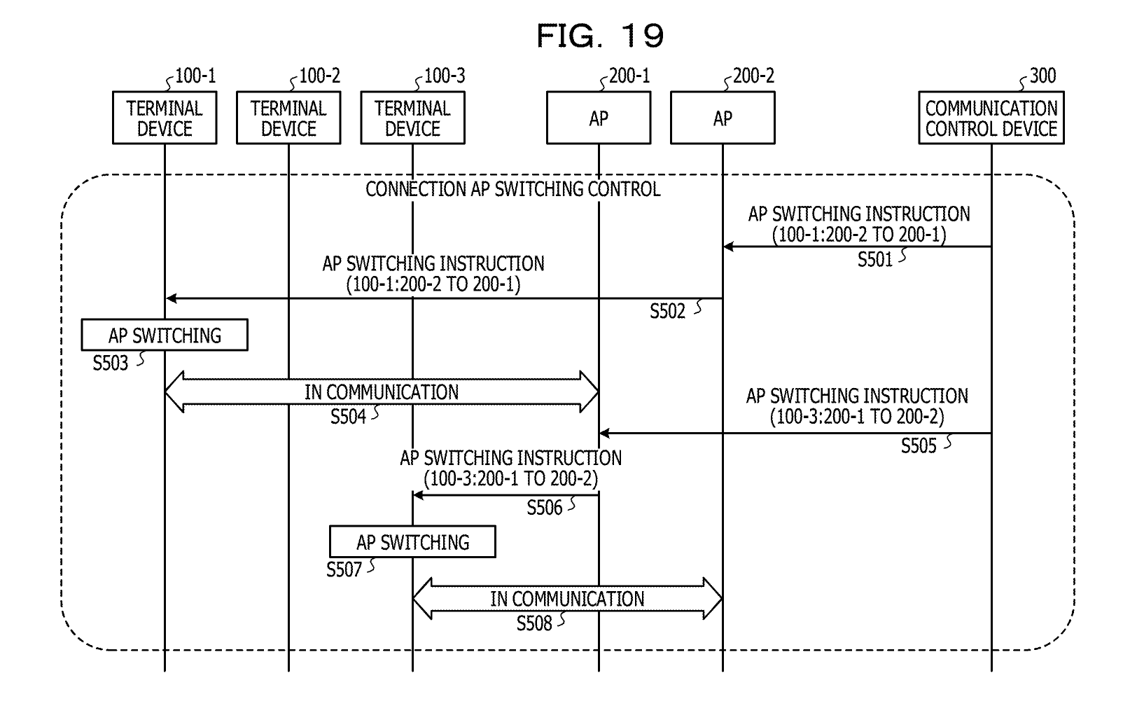

FIG. 19 illustrates an example of a sequence for the connection AP switching control. A case in which the combination no. 2 in FIG. 7 is selected as the combination of the terminal devices 100 and the access points 200 is discussed in FIG. 19.

The communication control device 300 transmits an AP switching instruction to the access point 200-2 (S501). The AP switching instruction in S501 includes switching the connection target of the terminal device 100-1 from the access point 200-2 to the access point 200-1. Because the AP switching instruction in S501 is a message transmitted to the terminal device 100-1, the access point 200-2 that is in communication with the terminal device 100-1 becomes the transmission destination of the switching instruction. The access point 200-2 receives the AP switching instruction and transmits the received AP connection instruction to the terminal device 100-1 (S502).

The terminal device 100-1 receives the AP switching instruction and performs the AP switching processing (S503). The terminal device 100-1 stores the fact that the access point 200 that is the connection target is the access point 200-1 in an internal memory during the AP switching processing in S503. The terminal device 100-1 changes the transmission destination of the packets so that communication is carried out via the access point 200-1 in the subsequent communication. As a result, the terminal device 100-1 enters communication with the access point 200-1 (S504).

Similarly, the communication control device 300 switches the connection target of the terminal device 100-3 from the access point 200-1 to the access point 200-2 (S505 to S508).

In the modified example of the third embodiment, the communication control device 300 transmits the AP switching instruction to the terminal device 100. The terminal device 100 that receives the AP switching instruction switches the access point 200 that is the connection target in accordance with the AP switching instruction. As a result, the packet transmission frequencies between the terminal devices 100 and the access points 200 and between the access points 200 and the communication control device 300 are reduced and the amount of communication in the communication system 10 can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device configured to control a wireless connection between a plurality of terminal devices and a plurality of access points, the communication control device comprising:
a memory; and
a processor coupled to the memory and configured to:
acquire a terminal communication bandwidth which indicates a communication bandwidth to be used by the terminal devices for communication, and a provided communication bandwidth which indicates a communication bandwidth provided by the respective plurality of access points to the respective plurality of terminal devices;
select the access point to be wirelessly connected with each of the plurality of terminal devices based on the terminal communication bandwidth and the provided communication bandwidth; and
control so that the respective plurality of terminal devices are wirelessly connected with the selected access point.

2. The communication control device as in claim 1, wherein the processor
selects the access point to be wirelessly connected to the respective plurality of terminal devices so that a total of the terminal communication bandwidths of the terminal devices to be wirelessly connected to one access point is equal to or less than the respective provided communication bandwidths of the one access point.

3. The communication control device as in claim 2, wherein the processor
calculates a ratio of the terminal communication bandwidth with respect to the provided communication bandwidth, and selects a combination in which a total of the ratios of the terminal devices to be wirelessly connected to the access points is one or less among all of the access points, as a combination of the access points to be wirelessly connected to the plurality of terminal devices.

4. The communication control device as in claim 3, wherein,
when there is no combination in which the total of the ratios of the terminal devices to be wirelessly connected to the access point is one or less among all of the access points, the processor selects a combination in which a sum of the respective totals of the plurality of access points is the smallest, as a combination of the access points to be wirelessly connected to the plurality of terminal devices.

5. The communication control device as in claim 3, wherein,
when there is no combination in which the total of the ratios of the terminal devices to be wirelessly connected to the access point is one or less among all of the access points, the processor selects a combination in which a distribution of the respective totals of the plurality of access points is the smallest, as a combination of the access points to be wirelessly connects to the plurality of terminal devices.

6. The communication control device as in claim 3, wherein,
when there is no combination in which the total of the ratios of the terminal devices to be wirelessly connected to the access point is one or less among all of the access points, the processor selects a combination of the access points to be wirelessly connected to the plurality of terminal devices based on a priority level for the respective communication of the plurality of terminal devices.

7. The communication control device as in claim 1, wherein the processor
receives, from the terminal device, information pertaining to the terminal communication bandwidth via the access point wirelessly connected to the terminal device.

8. The communication control device as in claim 1, wherein the processor
controls the terminal device so as to be wirelessly connected to any of the plurality of access points,
measures a communication amount of the terminal device over a predetermined time period, and
calculates the terminal communication bandwidth of the terminal device based on the communication amount measured over the predetermined time period.

9. The communication control device as in claim 1, wherein the processor
receives, from the terminal device, information pertaining to a service to be used by the terminal device via the access point wirelessly connected to the terminal device, and
acquires a communication bandwidth corresponding to the received information pertaining to the service, as the terminal communication bandwidth of the terminal device.

10. The communication control device as in claim 1, wherein the processor
selects a connection of a first terminal device among the plurality of terminal devices and a first access point among the plurality of access points, and
when the first terminal device is wirelessly connected to a second access point other than the first access point, transmits, to the second access point, a disconnection instruction for disconnecting the wireless connection with the first terminal device, and transmits a connection instruction to the first access point for wirelessly connecting with the first terminal device.

11. The communication control device as in claim 1, wherein the processor
selects a connection of a first terminal device among the plurality of terminal devices and a first access point among the plurality of access points, and
when the first terminal device is wirelessly connected to a second access point other than the first access point, transmits, to the first and second access points, a connection instruction to instruct the access point wirelessly connected to the first terminal device to switch from the second access point to the first access point.

12. The communication control device as in claim 1, wherein the processor
selects a connection of a first terminal device among the plurality of terminal devices and a first access point among the plurality of access points, and
when the first terminal device is wirelessly connected to a second access point other than the first access point which is selected as the wireless connection, transmits, via the second access point to the first terminal device, a connection instruction to instruct the first terminal device to switch the access point to which the first terminal device is wirelessly connected, from the second access point to the first access point.

13. The communication control device as in claim 1, wherein
the terminal device and the access point carry out the wireless connection in compliance with a communication standard pertaining to near field wireless communication.

14. A communication system comprising:
a plurality of terminal devices;
a plurality of access points configured to communicate with the plurality of terminal devices; and
a communication control device configured to control a wireless connection between the plurality of terminal devices and the plurality of access points, wherein the communication control device
acquire a terminal communication bandwidth which indicates a communication bandwidth to be used by the terminal devices for communication, and a provided communication bandwidth which indicates a communication bandwidth provided by the respective plurality of access points to the respective plurality of terminal devices,
select the access point to be wirelessly connected with each of the plurality of terminal devices based on the terminal communication bandwidth and the provided communication bandwidth, and
control so that the respective plurality of terminal devices are wirelessly connected with the selected access point.

15. A communication method configured to control a wireless connection between a plurality of terminal devices and a plurality of access points, the communication method comprising:
acquiring, by a processor, a terminal communication bandwidth which indicates a communication bandwidth to be used by the terminal devices for communication, and a provided communication bandwidth which indicates a communication bandwidth provided by the respective plurality of access points to the respective plurality of terminal devices;
selecting, by a processor, the access point to be wirelessly connected with each of the plurality of terminal devices based on the terminal communication bandwidth and the provided communication bandwidth; and
controlling, by a processor, so that the respective plurality of terminal devices are wirelessly connected with the selected access point.
